(19) United States
(12) Patent Application Publication
(10) Pub. No.: US 2023/0306270 A1
(43) Pub. Date: Sep. 28, 2023

(54) LEARNING DEVICE, LEARNING METHOD, AND LEARNING PROGRAM

(71) Applicant: NEC Corporation, Minato-ku, Tokyo (JP)

(72) Inventor: Riki ETO, Tokyo (JP)

(73) Assignee: NEC Corporation, Minato-ku, Tokyo (JP)

(21) Appl. No.: 18/023,225

(22) PCT Filed: Aug. 31, 2020
(86) PCT No.: PCT/JP2020/032848

§ 371 Date: Feb. 24, 2023

(51) Int. Cl. G06N 3/092

(52) U.S. Cl. CPC G06N 3/092

(57) ABSTRACT

A first inverse reinforcement learning execution unit 91 derives each weight of candidate features, which are plural features as candidates, included in a first objective function by inverse reinforcement learning using the candidate features. A feature selection unit 92 selects a feature when one feature is selected from the candidate features, from which each weight is derived, in such a manner that a reward represented using the feature is estimated to get the closest to an ideal reward result. A second inverse reinforcement learning execution unit 93 generates a second objective function by inverse reinforcement learning using the selected feature.

### TECHNICAL FIELD

The present invention relates to a learning device, a learning method, and a learning program for performing inverse reinforcement learning.

### BACKGROUND ART

In the field of machine learning, inverse reinforcement learning technology is known. In inverse reinforcement learning, expert decision-making history data are used to learn the weight (parameter) of each feature in an objective function.

In addition, in the field of machine learning, a technique for automatically determining a feature(s). In Non-Patent Literature 1, a feature selection technique based on “Teaching Risk” is disclosed. In a method described in Non-Patent Document 1, an ideal parameter in the objective function is assumed to compare the ideal parameter with a parameter in the process of being learned in order to select, as an important feature, a feature that makes the difference between the two parameters smaller.

### CITATION LIST

### Non Patent Literature

NPL 1: Luis Haug, et al., “Teaching Inverse Reinforcement Learners via Features and Demonstrations”, Proceedings of the 32nd International Conference on Neural Information Processing Systems, pp. 8473-8482, December 2018.

### SUMMARY OF INVENTION

### Technical Problem

When inverse reinforcement learning is performed, a user is required to specify a feature included in the objective function. However, when inverse reinforcement learning is applied to a real problem, there is a need to design features of the objective function in consideration of various trade-off relationships. Therefore, there is a problem that the features of the objective function when performing inverse reinforcement learning will be expensive to design.

Therefore, it is also considered to select a feature(s) using the method described in Non-Patent Literature 1. Although the method described in Non-Patent Literature 1 is on the assumption that the ideal parameter is presupposed, the method of deriving such an ideal parameter itself is inherently unclear. Therefore, it is difficult to use the method described in Non-Patent Literature 1 as it is in order to select a feature for inverse reinforcement learning.

Therefore, it is an exemplary object of the present invention to provide a learning device, a learning method, and a learning program capable of supporting the selection of a feature of an objective function used in inverse reinforcement learning.

### Solution to Problem

A learning device according to the present invention includes: a first inverse reinforcement learning execution unit which derives each weight of candidate features, which are plural features as candidates, included in a first objective function by inverse reinforcement learning using the candidate features; a feature selection unit which selects a feature when one feature is selected from the candidate features, from which each weight is derived, in such a manner that a reward represented using the feature is estimated to get the closest to an ideal reward result; and a second inverse reinforcement learning execution unit which generates a second objective function by inverse reinforcement learning using the selected feature.

A learning method according to the present invention includes: deriving each weight of candidate features, which are plural features as candidates, included in a first objective function by inverse reinforcement learning using the candidate features; selecting a feature when one feature is selected from the candidate features, from which each weight is derived, in such a manner that a reward represented using the feature is estimated to get the closest to an ideal reward result; and generating a second objective function by inverse reinforcement learning using the selected feature.

A learning program according to the present invention causes a computer to execute: first inverse reinforcement learning execution processing to derive each weight of candidate features, which are plural features as candidates, included in a first objective function by inverse reinforcement learning using the candidate features; feature selection processing to select a feature when one feature is selected from the candidate features, from which each weight is derived, in such a manner that a reward represented using the feature is estimated to get the closest to an ideal reward result; and second inverse reinforcement learning execution processing to generate a second objective function by inverse reinforcement learning using the selected feature.

### Advantageous Effects of Invention

According to the present invention, the selection of a feature(s) of an objective function used in inverse reinforcement learning can be supported.

### BRIEF DESCRIPTION OF DRAWINGS

FIG. 1 It depicts a block diagram illustrating a configuration example of a first exemplary embodiment of a learning device according to the present invention.

FIG. 2 It depicts a flowchart illustrating an operation example of the learning device of the first exemplary embodiment.

FIG. 3 It depicts a block diagram illustrating a configuration example of a second exemplary embodiment of a learning device according to the present invention.

FIG. 4 It depicts an explanatory chart illustrating an example of feature candidates presented to a user.

FIG. 5 It depicts a flowchart illustrating an operation example of the learning device of the second exemplary embodiment.

FIG. 6 It depicts a block diagram illustrating the outline of a learning device according to the present invention.

FIG. 7 It depicts a schematic block diagram illustrating the configuration of a computer according to at least one of the exemplary embodiments.

### DESCRIPTION OF EMBODIMENT

Exemplary embodiments of the present invention will be described below with reference to the drawings.

### Exemplary Embodiment 1

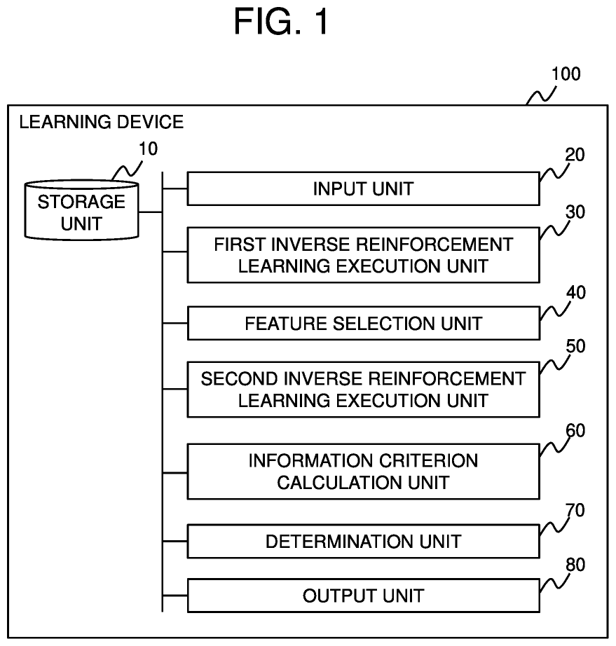

FIG. 1 is a block diagram illustrating a configuration example of a first exemplary embodiment of a learning device according to the present invention. A learning device 100 of the exemplary embodiment is a device for performing inverse reinforcement learning to estimate a reward (function) from the behavior of a target person. The learning device 100 includes a storage unit 10, an input unit 20, a first inverse reinforcement learning execution unit 30, a feature selection unit 40, a second inverse reinforcement learning execution unit 50, an information criterion calculation unit 60, a determination unit 70, and an output unit 80.

The storage unit 10 stores information necessary for the learning device 100 to perform various processing. The storage unit 10 may also store expert decision-making history data (which may also be called trajectories) used by the first inverse reinforcement learning execution unit 30 and the second inverse reinforcement learning execution unit 50 to perform learning to be described later, and candidates for a feature of an objective function. Further, the storage unit 10 may store each feature candidate and information (label) indicative of the content of the feature in association with each other.

Further, the storage unit 10 may store mathematical optimization solvers to realize the first inverse reinforcement learning execution unit 30 and the second inverse reinforcement learning execution unit 50 to be described later. Note that the contents of the mathematical optimization solvers are optional, which should be determined according to the environment and device to run the mathematical optimization solvers. For example, the storage unit 10 is realized by a magnetic disk and the like.

The input unit 20 accepts input of information necessary for the learning device 100 to perform various processing. For example, the input unit 20 may accept input of the decision-making history data described above.

The first inverse reinforcement learning execution unit 30 sets an objective function (hereinafter referred to as a first objective function) using plural features as candidates (hereinafter referred to as candidate features). Specifically, the first inverse reinforcement learning execution unit 30 may set the first objective function using, as the candidate features, all features assumed as candidates. Then, the first inverse reinforcement learning execution unit 30 derives, by inverse reinforcement learning, each weight w* of candidate features included in the first objective function.

Since the first objective function thus learned represents a reward using all assumed features, the first objective function can be said to represent an ideal reward result that assumes multiple factors. Further, in the following description, a list including all candidate features used to learn the first objective function may also be referred to as a feature list A.

When one of features is selected from the candidate features from which each weight w* is derived, the feature selection unit 40 selects such a feature that the reward represented using the feature is estimated to be the closest to the ideal reward result. Such a feature can be called a feature that has the most influence on the reward among the candidate features. In other words, it can be said that the feature selection unit 40 performs processing to select one of features from the feature list A described above.

For example, the feature selection unit 40 may also select, as the feature estimated to be the closest to the ideal reward result, a feature determined to be most important by experts. Further, the feature selection unit 40 may use the method described in Non-Patent Document 1 to select a feature from among candidate features so that a feature of which even experts are not aware can be selected.

In the following, a method of selecting one feature from candidate features using the Teaching Risk technique described in Non-Patent Document 1 will be described. The Teaching Risk described in Non-Patent Document 1 is a value indicative of the (potential) partial optimality of the objective function learned by inverse reinforcement learning. It is assumed that the objective function is optimized (learned) by inverse reinforcement learning based on an arbitrarily selected feature in order to describe the partial optimality of the objective function. In this case, although the objective function optimized (learned) by inverse reinforcement learning is partially optimal, it may not be (potentially) overall optimal. This is because the feature is arbitrarily selected and the optimization (learning) by the other features that were not selected cannot be considered.

Further, as another assumption, an objective function in which any feature is unselected is assumed. In this case, the objective function and an ideal objective function with overall optimization are mostly different from each other compared with the case where a feature is selected. Therefore, the Teaching Risk in the objective function with any feature unselected is in the maximum state. In this state, since the selection of a feature to reduce the Teaching Risk results in reducing the difference between an ideal feature vector and an actual feature vector to select a feature for reducing the potential partial optimality, it corresponds to selecting a feature estimated to get closer to the ideal reward result.

In the following, the definition of Teaching Risk will be described. Information representing a difference between the ideal feature vector and the actual feature vector is referred to as WorldView. The WorldView can be expressed by a matrix. In a case of sparse learning, matrix A^{L} indicative of the WorldView corresponds to a matrix in which diagonal components for a used feature are 1 and the other components are 0. In other words,

Current feature vector=A^{L}·ideal feature vector.

When the ideal weight is set as w*, Teaching Risk (ρ(A^{L};w*)) can be expressed in Equation 1 below.

$$[ Math . 1 ]$$

$$ρ ( {A}^{L} ; {w}^{*} ) := {max}_{v ∈ ker {A}^{L} , ‖ v ‖ \leq 1} 〈 {w}^{*} , v 〉 \qquad ( Equation 1 )$$

In Equation 1, the left side expresses the maximum value of an inner product between an ideal weight and a vector belonging to the WorldView kernel. Note that the kernel of the matrix means a set of vectors that yield a zero vector by a linear transformation of the matrix, which corresponds to a cosine between this vector set and the ideal weight in the case of the Teaching Risk.

Therefore, the feature selection unit 40 may regard each derived weight w* of the candidate features as the optimal parameter to select a feature that minimizes the Teaching Risk from among the candidate features.

In the following description, it is assumed that the feature selected by the feature selection unit 40 is added to a feature list B. Specifically, the feature selection unit 40 removes the selected feature from the feature list A described above and adds the selected feature to the feature list B. Note that the feature list B should be initialized to an empty set in the initial state.

The second inverse reinforcement learning execution unit 50 generates a second objective function by inverse reinforcement learning using the selected feature. Specifically, the second inverse reinforcement learning execution unit 50 uses the selected feature (specifically, the feature added to the feature list B) to set an objective function (hereinafter referred to as a second objective function). Then, the second inverse reinforcement learning execution unit 50 derives each weight w of features included in the second objective function by inverse reinforcement learning. Note that when a feature is newly selected by the feature selection unit 40 (specifically, when a feature is further added to the feature list B), the second inverse reinforcement learning execution unit 50 sets the second objective function including the newly selected feature and the already selected feature, and derives each weight of the features included in the set second objective function.

The information criterion calculation unit 60 calculates an information criterion of the generated second objective function. The method of calculating the information criterion is optional, and any calculation method such as AIC (Akaike's Information Criterion), BIC (Bayesian Information Criterion), and FIC (Focused Information Criterion) can be used. It should be predetermined which calculation method is used.

The determination unit 70 determines whether or not to further select a feature from among the candidate features based on the learning results of the second objective function. For example, the determination unit 70 may determine whether or not to further select a feature from among the candidate features based on whether or not a predetermined condition is met such as the number of times the second objective function is learned or the execution time. This condition may also be determined according to the number of sensors loadable, for example, for robot control or the like.

Further, the determination unit 70 may determine whether or not to further select a feature based on the information criterion calculated by the information criterion calculation unit 60. Specifically, when the information criterion is monotonically increasing, the determination unit 70 determines to further select a feature.

When it is determined by the determination unit 70 to further select a feature, the feature selection unit 40 further selects a feature other than the already selected feature from among the candidate features, the second inverse reinforcement learning execution unit 50 executes inverse reinforcement learning by adding the newly selected feature to generate a second objective function, and the information criterion calculation unit 60 calculates the information criterion of the generated second objective function. After that, these processes are repeated.

In other words, when it is determined by the determination unit 70 to further select a feature, the feature selection unit 40 further selects a feature from the feature list A and adds the feature to the feature list B, and the second inverse reinforcement learning execution unit 50 derives a weight of the second objective function including the feature included in the feature list B.

Note that when it is determined by the determination unit 70 whether or not to further select a feature from among the candidate features based on whether or not the predetermined condition is met without using the information criterion, the learning device 100 may not include the information criterion calculation unit 60.

However, when the determination unit 70 uses the information criterion calculated by the information criterion calculation unit 60 to determine whether or not to further select a feature, a trade-off between the number of features and the fitting can be realized. In other words, fitting for existing data can be enhanced by expressing the objective function using all the features, but overfitting may occur. On the other hand, in the exemplary embodiment, use of the information criterion can realize a sparse objective function while expressing the objective function using more preferable features.

The output unit 80 outputs information about the generated second objective function. Specifically, the output unit 80 outputs a set of features included in the generated second objective function, and the weights of the features. For example, the output unit 80 may also output a set of features when the information criterion becomes the maximum and the weights of the features.

It is considered that the information criterion when the determination unit 70 determines not to further select a feature in a case of determining whether or not to further select a feature based on whether or not the information criterion is monotonically increasing is smaller than the information criterion of the previous second objective function. Therefore, in this case, the output unit 80 should output information about the previous second objective function.

Further, the output unit 80 may output features in the order selected by the feature selection unit 40. Since the order of features selected by the feature selection unit 40 is the order of features coming close to the ideal reward result, a user can figure out the order of features that can more affect the reward. Further, the output unit 80 may output information (label) indicative of the contents of the features together. The user interpretability can be increased by outputting the features in this way.

The input unit 20, the first inverse reinforcement learning execution unit 30, the feature selection unit 40, the second inverse reinforcement learning execution unit 50, the information criterion calculation unit 60, the determination unit 70, and the output unit 80 are implemented by a processor (for example, a CPU (Central Processing Unit) or a GPU (Graphics Processing Unit)) that operates according to a program (learning program).

For example, the program may be stored in the storage unit 10 included in the learning device 100, and the processor may read the program to work as the input unit 20, the first inverse reinforcement learning execution unit 30, the feature selection unit 40, the second inverse reinforcement learning execution unit 50, the information criterion calculation unit 60, the determination unit 70, and the output unit 80 according to the program. Further, the functionality of the learning device 100 may be provided in a SaaS (Software as a Service) form.

Further, the input unit 20, the first inverse reinforcement learning execution unit 30, the feature selection unit 40, the second inverse reinforcement learning execution unit 50, the information criterion calculation unit 60, the determination unit 70, and the output unit 80 may be implemented in dedicated hardware, respectively. Further, some or all of components of each device may be realized by a general-purpose or dedicated circuit (circuitry), or realized by the processor or a combination thereof. These components may be configured by a single chip, or configured by two or more chips connected through a bus. Further, some or all of components of each device may be realized by a combination of the circuitry described above and the program.

Further, when some or all of the components of the learning device 100 are realized by two or more information processing devices or circuits, the two or more information processing devices or circuits may be arranged centrally or in a distributed manner. For example, each of the information processing devices or circuits may also be realized as a form connected through a communication network such as a client server system or a cloud computing system.

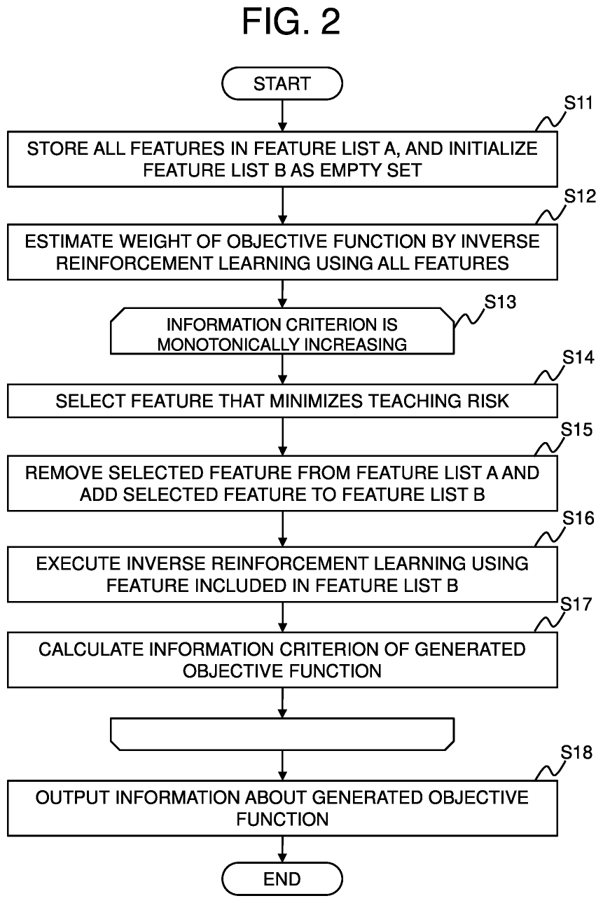

Next, the operation of the learning device 100 of the exemplary embodiment will be described. FIG. 2 is an explanatory chart illustrating an operation example of the learning device 100 of the exemplary embodiment. In FIG. 2, the operation to select a feature based on the information criterion using the Teaching Risk and the feature lists will be described.

First, the first inverse reinforcement learning execution unit 30 stores all features in the feature list A, and initializes the feature list B as an empty set (step S11). Next, the first inverse reinforcement learning execution unit 30 estimates the weight w* of the objective function by inverse reinforcement learning using all the features (step S12).

After that, processes from step S14 to step S17 are repeated while the information criterion is monotonically increasing. In other words, when determining that the information criterion is monotonically increasing, the determination unit 70 performs control to repeatedly execute the processes from step S14 to step S17 (step S13).

First, the feature selection unit 40 selects, from the feature list A, one feature that minimizes the Teaching Risk using the weight w* and the feature stored in the feature list B (step S14). Then, the feature selection unit 40 removes the selected feature from the feature list A and adds the selected feature to the feature list B (step S15). The second inverse reinforcement learning execution unit 50 executes inverse reinforcement learning using the feature included in the feature list B (step S16), and the information criterion calculation unit 60 calculates the information criterion of the generated objective function (step S17).

When the information criterion stops monotonically increasing, the output unit 80 outputs information about the generated objective function (step S18).

As described above, in the exemplary embodiment, the first inverse reinforcement learning execution unit 30 derives each weight of candidate features included in the first objective function by inverse reinforcement learning using the candidate features, and the feature selection unit 40 selects a feature estimated to get the closest to the ideal reward result from among the candidate features from which each weight is derived. Then, the second inverse reinforcement learning execution unit 50 generates a second objective function by inverse reinforcement learning using the selected feature. Thus, the selection of a feature of the objective function used in inverse reinforcement learning can be supported.

In other words, in the exemplary embodiment, since a proper feature is selected in the process of machine learning, the proper feature can be selected at low cost from among a huge number of feature candidates.

### Exemplary Embodiment 2

Next, a second exemplary embodiment of a learning device of the present invention will be described. In the second exemplary embodiment, such an aspect that feature candidates used by learning the second objective function is provided to the user to let the user select any one of the features.

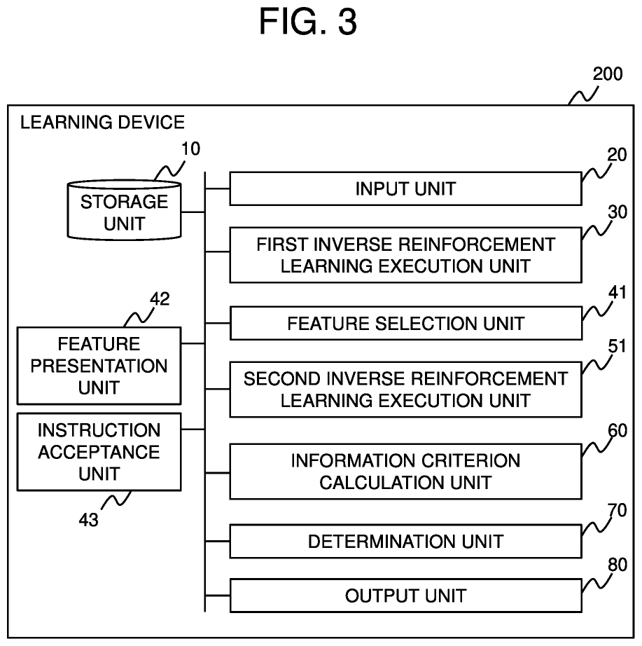

FIG. 3 is a block diagram illustrating a configuration example of the second exemplary embodiment of a learning device according to the present invention. A learning device 200 of the exemplary embodiment includes the storage unit 10, the input unit 20, the first inverse reinforcement learning execution unit 30, a feature selection unit 41, a feature presentation unit 42, an instruction acceptance unit 43, a second inverse reinforcement learning execution unit 51, the information criterion calculation unit 60, the determination unit 70, and the output unit 80.

In other words, the learning device 200 of the exemplary embodiment is different from the learning device 100 of the first exemplary embodiment in that the learning device 200 includes the feature selection unit 41, the feature presentation unit 42, the instruction acceptance unit 43, and the second inverse reinforcement learning execution unit 51 instead of the feature selection unit 40 and the second inverse reinforcement learning execution unit 50. The other components are the same as those in the first exemplary embodiment.

Like the feature selection unit 40 of the first exemplary embodiment, the feature selection unit 41 selects a feature from candidate features. At the time, the feature selection unit 41 of the exemplary embodiment selects one or more top features in a predetermined number of features to be estimated to get closer to the ideal reward result. Note that when the number of selected features is one, processing performed by the feature selection unit 41 is the same as processing performed by the feature selection unit 40 of the first exemplary embodiment.

The feature presentation unit 42 presents the feature(s) selected by the feature selection unit 41 to the user. For example, when two or more features are selected, the feature presentation unit 42 may display the features in order from the top feature. Further, when there is a label for each feature, the feature presentation unit 42 may display the label corresponding to the feature together.

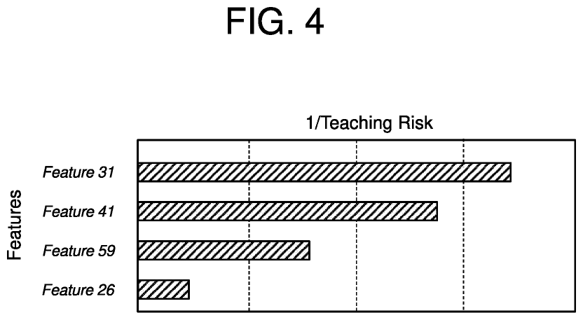

FIG. 4 is an explanatory chart illustrating an example of feature candidates presented to the user. The example illustrated in FIG. 4 illustrates a graph with the reciprocal of the Teaching Task illustrated in the first exemplary embodiment on the horizontal axis and the candidate features on the vertical axis, respectively, which indicates that the feature presentation unit 42 selectively displays top four features.

The instruction acceptance unit 43 accepts a selection instruction from the user for the feature candidates presented by the feature presentation unit 42. For example, the instruction acceptance unit 43 may accept the feature selection instruction from the user through a pointing device. Note that the selection instruction accepted by the instruction acceptance unit 43 may be to instruct the selection of one feature or the selection of two or more features. Further, when the user determines that there is no corresponding feature, the instruction acceptance unit 43 may accept such an instruction not to select any feature.

The second inverse reinforcement learning execution unit 51 generates a second objective function by inverse reinforcement learning using the feature(s) selected by the user. For example, when one feature is selected by the user, the second inverse reinforcement learning execution unit 51 should perform the same processing as that performed by the second inverse reinforcement learning execution unit 50 of the first exemplary embodiment. Further, for example, when two or more features are selected, the second inverse reinforcement learning execution unit 51 may generate a second objective function by adding two or more features (for example, to the feature list B). Note that when no feature is selected, the second inverse reinforcement learning execution unit 51 does not have to generate the second objective function.

The input unit 20, the first inverse reinforcement learning execution unit 30, the feature selection unit 41, the feature presentation unit 42, the instruction acceptance unit 43, the second inverse reinforcement learning execution unit 51, the information criterion calculation unit 60, the determination unit 70, and the output unit 80 are implemented by a processor of a computer that operates according to the program (learning program).

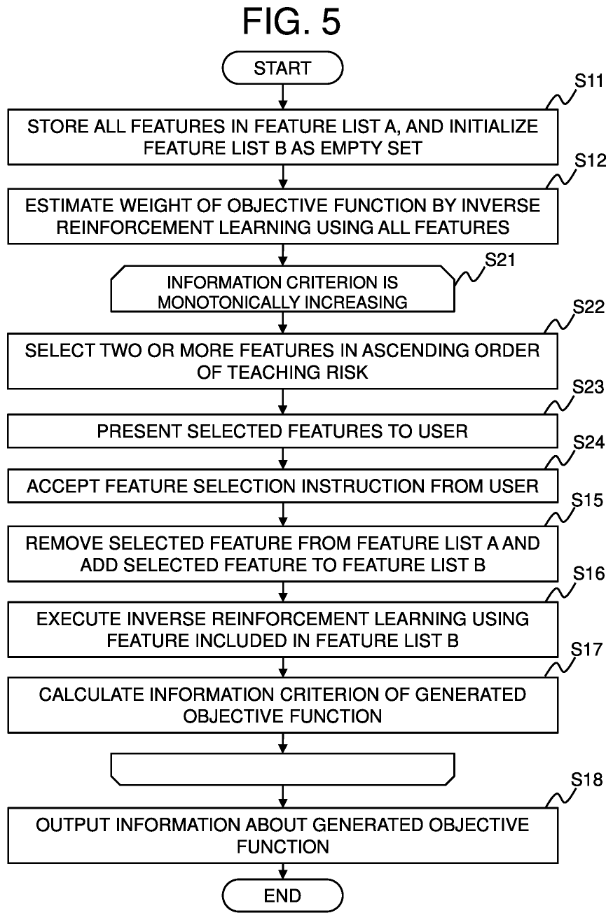

Next, the operation of the learning device 200 of the exemplary embodiment will be described. FIG. 5 is an explanatory chart illustrating an operation example of the learning device 200 of the exemplary embodiment. The processes from step S11 to step S12 to generate the first objective function are the same as the processes illustrated in FIG. 2. After that, processes from step S22 to step S24 and processes from step S15 to step S17 are repeated while the information criterion is monotonically increasing. In other words, when determining that the information criterion is monotonically increasing, the determination unit 70 performs control to repeatedly execute the processes from step S22 to step S24 and from step S15 to step S17 (step S21).

The feature selection unit 41 selects two or more features in ascending order of the Teaching Risk (step S22). The feature presentation unit 42 presents the features selected by the feature selection unit 41 to the user (step S23). Then, the instruction acceptance unit 43 accepts a feature selection instruction from the user (step S24). Then, the feature selection unit 41 performs the processes from step S15 to step S17 illustrated in FIG. 2. After that, a process in step S18 to output information about the generated objective function is performed.

As described above, in the exemplary embodiment, the feature selection unit 41 selects one or more top features corresponding to a predetermined number and to be estimated to get closer to the ideal reward result, and the feature presentation unit 42 presents the selected one or more features to the user. Then, the instruction acceptance unit 43 accepts a selection instruction from the user for the presented features, and the second inverse reinforcement learning execution unit 51 generates a second objective function by inverse reinforcement learning using a feature(s) selected by the user.

Thus, in addition to the effect of the first exemplary embodiment, learning that reflects the knowledge of users including experts can proceed efficiently.

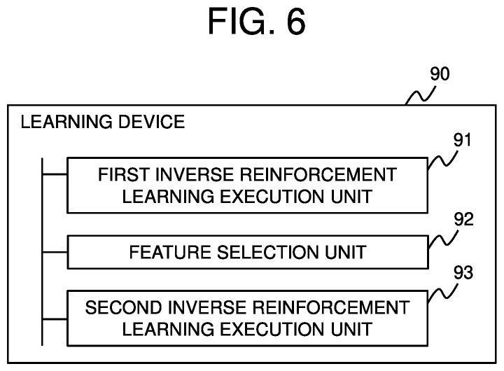

Next, the outline of the present invention will be described. FIG. 6 is a block diagram illustrating the outline of a learning device according to the present invention. A learning device 90 according to the present invention includes a first inverse reinforcement learning execution unit 91 (for example, the first inverse reinforcement learning execution unit 30) to derive each weight (for example, w*) of candidate features included in the first objective function by inverse reinforcement learning using candidate features which are plural (specifically, all) features as candidates, a feature selection unit 92 (for example, the feature selection unit 40) to select a feature when one feature is selected from candidate features, from which each weight (for example, w*) is derived, in such a manner that a reward represented using the feature is estimated to get the closest to the ideal reward result, and a second inverse reinforcement learning execution unit 93 (for example, the second inverse reinforcement learning execution unit 50) to generate a second objective function by inverse reinforcement learning using the selected feature.

Such a configuration can support the selection of a feature of the objective function used in inverse reinforcement learning.

Further, the feature selection unit 92 may regard each derived weight (for example, w*) of the candidate features as the optimal parameter to select, from the candidate features, a feature that minimizes the partial optimality (for example, Teaching Risk) of the objective function.

The learning device 90 may further include a determination unit (for example, the determination unit 70) to determine whether or not to further select a feature from the candidate features based on the learning results of the second objective function. Then, when it is determined to further select a feature, the feature selection unit 92 may newly select a feature other than the already selected feature from among the candidate features, and the second inverse reinforcement learning execution unit 93 may execute inverse reinforcement learning by adding the newly selected feature to generate a second objective function.

The learning device 90 may further include an information criterion calculation unit (for example, the information criterion calculation unit 60) to calculate the information criterion of the generated second objective function. Then, the determination unit may also determine whether or not to further select a feature from among the candidate features based on the information criterion. Such a configuration can realize a trade-off between the number of features and the fitting.

Specifically, when the information criterion is monotonically increasing, the determination unit may determine to further select a feature from among the candidate features.

The learning device 90 may further include an output unit (for example, the output unit 80) to output features included in the second objective function and the corresponding weights of the features when the information criterion becomes the maximum.

Further, the output unit may output the features in the order selected by the feature selection unit 92.

The learning device 90 (for example, the learning device 200) may further include a feature presentation unit (for example, the feature presentation unit 42) to present the features selected by the feature selection unit 92 to the user, and an instruction acceptance unit (for example, the instruction acceptance unit 43) to accept a selection instruction from the user for the presented features. Then, the feature selection unit 92 may select one or more top features corresponding to a predetermined number and to be estimated to get closer to the ideal reward result, the feature presentation unit may present the selected one or more features to the user, and the second inverse reinforcement learning execution unit 93 may generate a second objective function by inverse reinforcement learning using a feature(s) selected by the user.

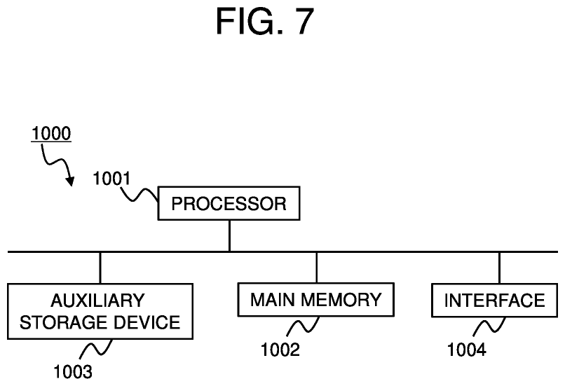

FIG. 7 is a schematic block diagram illustrating the configuration of a computer according to at least one of the exemplary embodiments. A computer 1000 includes a processor 1001, a main storage device 1002, an auxiliary storage device 1003, and an interface 1004.

The learning device 90 described above is mounted in the computer 1000.

Then, the operation of each processing unit described above is stored in the auxiliary storage device 1003 in the form of a program (learning program). The processor 1001 reads the program from the auxiliary storage device 1003, expands the program in the main storage device 1002, and executes the above processing according to the program.

Note that, in at least one of the exemplary embodiments, the auxiliary storage device 1003 is an example of a non-transitory tangible medium. As examples of non-transitory tangible media, there are a magnetic disk, a magneto-optical disk, a CD-ROM (Compact Disc Read-only memory), a DVD-ROM (Read-only memory), and a semiconductor memory connected through the interface 1004. Further, when this program is delivered to the computer 1000 by a communication line, the computer 1000 that received the delivery may expand the program in the main storage device 1002 and execute the above processing.

Further, the program may be to implement some of the functions described above. Further, the program may be a so-called differential file (differential program) that implements the functions described above in combination with another program already stored in the auxiliary storage device 1003.

Part or all of the aforementioned exemplary embodiments can also be described in supplementary notes below, but the present invention is not limited to the supplementary notes below.

(Supplementary Note 1)

A learning device including: a first inverse reinforcement learning execution unit which derives each weight of candidate features, which are a plurality of features as candidates, included in a first objective function by inverse reinforcement learning using the candidate features; a feature selection unit which selects a feature when one feature is selected from the candidate features, from which each weight is derived, in such a manner that a reward represented using the feature is estimated to get the closest to an ideal reward result; and a second inverse reinforcement learning execution unit which generates a second objective function by inverse reinforcement learning using the selected feature.

(Supplementary Note 2)

The learning device according to Supplementary Note 1, wherein the feature selection unit regards each derived weight of the candidate features as an optimal parameter to select a feature that minimizes partial optimality of an objective function from among the candidate features.

(Supplementary Note 3)

The learning device according to Supplementary Note 1 or Supplementary Note 2, further including a determination unit which determines whether or not to further select a feature from the candidate features based on learning results of the second objective function, wherein when it is determined to further select a feature, the feature selection unit newly selects a feature other than the already selected feature from among the candidate features, and the second inverse reinforcement learning execution unit executes inverse reinforcement learning by adding the newly selected feature to generate a second objective function.

(Supplementary Note 4)

The learning device according to Supplementary Note 3, further including an information criterion calculation unit which calculates an information criterion of the generated second objective function, wherein the determination unit determines whether or not to further select a feature from the candidate features based on the information criterion.

(Supplementary Note 5)

The learning device according to Supplementary Note 3, wherein when the information criterion is monotonically increasing, the determination unit determines to further select a feature from the candidate features.

(Supplementary Note 6)

The learning device according to any one of Supplementary Note 1 to Supplementary Note 5, further including an output unit which outputs features included in the second objective function and corresponding weights of the features when the information criterion becomes maximum.

(Supplementary Note 7)

The learning device according to Supplementary Note 6, wherein the output unit outputs the features in the order selected by the feature selection unit.

(Supplementary Note 8)

The learning device according to any one of Supplementary Note 1 to Supplementary Note 7, further including: a feature presentation unit which presents the features selected by the feature selection unit to a user; and an instruction acceptance unit which accepts a selection instruction from the user for the presented features, wherein the feature selection unit selects one or more top features in a predetermined number of features to be estimated to get closer to the ideal reward result, the feature presentation unit presents the selected one or more features to the user, and the second inverse reinforcement learning execution unit generates a second objective function by inverse reinforcement learning using a feature(s) selected by the user.

(Supplementary Note 9)

A learning method including: deriving each weight of candidate features, which are a plurality of features as candidates, included in a first objective function by inverse reinforcement learning using the candidate features; selecting a feature when one feature is selected from the candidate features, from which each weight is derived, in such a manner that a reward represented using the feature is estimated to get the closest to an ideal reward result; and generating a second objective function by inverse reinforcement learning using the selected feature.

(Supplementary Note 10)

The learning method according to Supplementary Note 9, wherein each derived weight of the candidate features is regarded as an optimal parameter to select a feature that minimizes the partial optimality of an objective function from among the candidate features.

(Supplementary Note 11)

A program storage medium which stores a learning program for causing a computer to execute: first inverse reinforcement learning execution processing to derive each weight of candidate features, which are a plurality of features as candidates, included in a first objective function by inverse reinforcement learning using the candidate features; feature selection processing to select a feature when one feature is selected from the candidate features, from which each weight is derived, in such a manner that a reward represented using the feature is estimated to get the closest to an ideal reward result; and second inverse reinforcement learning execution processing to generate a second objective function by inverse reinforcement learning using the selected feature.

(Supplementary Note 12)

The program storage medium according to Supplementary note 11, which stores the learning program for causing the computer to further regard each weight of the candidate features derived in the feature selection processing as an optimal parameter to select a feature that minimizes the partial optimality of an objective function from among the candidate features.

(Supplementary Note 13)

A learning program causing a computer to execute: first inverse reinforcement learning execution processing to derive each weight of candidate features, which are a plurality of features as candidates, included in a first objective function by inverse reinforcement learning using the candidate features; feature selection processing to select a feature when one feature is selected from the candidate features, from which each weight is derived, in such a manner that a reward represented using the feature is estimated to get the closest to an ideal reward result; and second inverse reinforcement learning execution processing to generate a second objective function by inverse reinforcement learning using the selected feature.

(Supplementary Note 14)

The learning program according to Supplementary Note 13, further causing the computer to regard each weight of the candidate features derived in the feature selection processing as an optimal parameter to select a feature that minimizes the partial optimality of an objective function from among the candidate features.

While the invention as claimed in this application has been described above, the invention is not limited to the above-mentioned embodiments. Various changes understandable to persons skilled in the art can be made in the configuration and details of the invention within the scope of the invention as claimed in this application.

### REFERENCE SIGNS LIST

10 storage unit
20 input unit
30 first inverse reinforcement learning execution unit
40, 41 feature selection unit
42 feature presentation unit
43 instruction acceptance unit
50, 51 second inverse reinforcement learning execution unit
60 information criterion calculation unit
70 determination unit
80 output unit
100, 200 learning device

What is claimed is:

1. A learning device comprising:
a memory storing instructions; and
one or more processors configured to execute the instructions to:
derive each weight of candidate features included in a first objective function by inverse reinforcement learning using the candidate features;
select a feature when one feature is selected from the candidate features in the first objective function the feature making a reward represented using the feature closest to an ideal reward result; and
generate a second objective function by inverse reinforcement learning using the selected feature.

2. The learning device according to claim 1, wherein the processor is configured to execute the instructions to regard each derived weight of the candidate features as an optimal parameter to select a feature that minimizes partial optimality of an objective function from among the candidate features.

3. The learning device according to claim 1, wherein the processor is configured to execute the instructions to:
determine whether or not to further select a feature from the candidate features based on learning results of the second objective function;
when it is determined to further select a feature, newly select a feature other than the already selected feature from among the candidate features; and
execute inverse reinforcement learning by adding the newly selected feature to generate a second objective function.

4. The learning device according to claim 3, wherein the processor is configured to execute the instructions to:
calculate an information criterion of the generated second objective function; and
determine whether or not to further select a feature from the candidate features based on the information criterion.

5. The learning device according to claim 4, wherein when the information criterion is monotonically increasing, the processor is configured to execute the instructions to determine to further select a feature from the candidate features.

6. The learning device according to claim 1, wherein the processor is configured to execute the instructions to output features included in the second objective function and corresponding weights of the features when the information criterion becomes maximum.

7. The learning device according to claim 6, wherein the processor is configured to execute the instructions to output the features in selected order.

8. The learning device according to claim 1, wherein the processor is configured to execute the instructions to:
present the selected features to a user;
accept a selection instruction from the user for the presented features;
select one or more top features in a predetermined number of features to be estimated to get closer to the ideal reward result;
present the selected one or more features to the user; and
generate a second objective function by inverse reinforcement learning using a feature selected by the user.

9. A learning method comprising:
deriving each weight of candidate features included in a first objective function by inverse reinforcement learning using the candidate features;
selecting a feature when one feature is selected from the candidate features in the first objective function the feature making a reward represented using the feature closest to an ideal reward result; and
generating a second objective function by inverse reinforcement learning using the selected feature.

10. The learning method according to claim 9, wherein the each derived weight of the candidate features is regarded as an optimal parameter to select a feature that minimizes partial optimality of an objective function from among the candidate features.

11. A non-transitory computer readable information recording medium storing a learning program for causing a computer to execute:
first inverse reinforcement learning execution processing to derive each weight of candidate features included in a first objective function by inverse reinforcement learning using the candidate features;
feature selection processing to select a feature when one feature is selected from the candidate features in the first objective function the feature making a reward represented using the feature closest to an ideal reward result; and
second inverse reinforcement learning execution processing to generate a second objective function by inverse reinforcement learning using the selected feature.

12. The non-transitory computer readable information recording medium according to claim 11, which stores the learning program for further causing the computer to regard the each weight of the candidate features derived in the feature selection processing as an optimal parameter to select a feature that minimizes the partial optimality of an objective function from among the candidate features.
